(19) United States
(12) Patent Application Publication
(10) Pub. No.: US 2022/0176842 A1
(43) Pub. Date: Jun. 9, 2022

(54) ELECTRIC VEHICLE (EV) CHARGING STATION MANAGEMENT

(71) Applicant: Honda Motor Co., Ltd., Tokyo (JP)

(72) Inventors: David Wong Cun, Fountain Valley, CA (US); Eri Izumi Maeda, Rancho Palos Verdes, CA (US)

(21) Appl. No.: 17/113,796

(22) Filed: Dec. 7, 2020

(51) Int. Cl. B60L 53/66; B60L 53/62; G06Q 50/06; G06Q 20/10; G06Q 20/08

(52) U.S. Cl. CPC B60L 53/665; B60L 53/62; G06Q 20/085; G06Q 20/102; G06Q 50/06

(57) ABSTRACT

According to one aspect, a system for electric vehicle (EV) charging station management may perform receiving an indication of an EV of a user initiating charging at an EV charging station, determining a charge time for the EV, the charge time indicative of an amount of time the EV charging station supplies a charge to the EV, receiving data indicative of a real-world user activity at a location within a threshold distance from the EV charging station, and adjusting a grace period associated with the charge time for the EV based on the data indicative of the real-world user activity. After expiration of the charge time and the grace period, the user may be billed a fee for occupying the EV occupying the EV charging station.

### BACKGROUND

An electric vehicle (EV) may charge at an EV charging station. Such charging stations may be located in a parking lot of a retailer or a store. Due to demand, some charging station service providers have idle fees for having one's EV plugged in and not actively charging. For example, an idle fee of fifty cents per minute may be imposed after the EV is fully charged. Further, an increased idle fee may be imposed after the EV is fully charged and the EV charging station is fully occupied. Some EV charging stations may provide a grace period prior to billing the idle fee to allow EV users or drivers to move their vehicles and thus avoid the idle fee or penalty.

### BRIEF DESCRIPTION

According to one aspect, a system for electric vehicle (EV) charging station management may include a processor and a memory storing instructions that are operable, when executed by the processor, to cause the processor to perform receiving an indication of an EV of a user initiating charging at an EV charging station, determining a charge time for the EV, the charge time indicative of an amount of time the EV charging station supplies a charge to the EV, receiving data indicative of a real-world user activity at a location within a threshold distance from the EV charging station, and adjusting the charge time for the EV, adjusting a charging rate for the EV, or adjusting a grace period associated with the charge time for the EV based on the data indicative of the real-world user activity. After expiration of the charge time and the grace period, the user may be billed a fee for occupying the EV occupying the EV charging station.

The charge time for the EV may be an estimated time to full charge of the EV. The real-world user activity may include physically moving an item to a grocery cart or a basket. The real-world user activity may include a monetary transaction above a threshold amount. The real-world user activity may include a dining experience at a restaurant. The real-world user activity may include adding items to a virtual shopping cart via a shopping application. The real-world user activity may include an interaction with an employee of a retail establishment.

The processor may notify the user of the adjustment of the charge time for the EV, the adjustment of the charging rate for the EV, or the adjustment to the grace period. The processor may notify the user of a threshold prior to the adjustment of the charge time for the EV, the adjustment of the charging rate for the EV, or the adjustment to the grace period. The processor may adjust a status of an order placed by the user via a shopping application based on the indication of the EV initiating charging at the EV charging station.

According to one aspect, a computer implemented method for EV charging station management may include receiving an indication of an EV of a user initiating charging at an EV charging station, determining a charge time for the EV, the charge time indicative of an amount of time the EV charging station supplies a charge to the EV, receiving data indicative of a real-world user activity at a location within a threshold distance from the EV charging station, and adjusting the charge time for the EV, adjusting a charging rate for the EV, or adjusting a grace period associated with the charge time for the EV based on the data indicative of the real-world user activity, wherein after expiration of the charge time and the grace period. The user may be billed a fee for occupying the EV occupying the EV charging station.

The charge time for the EV may be an estimated time to full charge of the EV. The real-world user activity may include physically moving an item to a grocery cart or a basket. The real-world user activity may include a monetary transaction above a threshold amount. The real-world user activity may include a dining experience at a restaurant. The real-world user activity may include adding items to a virtual shopping cart via a shopping application. The real-world user activity may include an interaction with an employee of a retail establishment.

The method for EV charging station management may include notifying the user of the adjustment of the charge time for the EV, the adjustment of the charging rate for the EV, or the adjustment to the grace period. The method for EV charging station management may include notifying the user of a threshold prior to the adjustment of the charge time for the EV, the adjustment of the charging rate for the EV, or the adjustment to the grace period.

According to one aspect, a system for EV charging station management may include a processor and a memory storing instructions that are operable, when executed by the processor, to cause the processor to perform receiving an indication of an EV of a user initiating charging at an EV charging station, determining a charge time for the EV, the charge time indicative of an amount of time the EV charging station supplies a charge to the EV, receiving data indicative of a real-world user activity at a location within a threshold distance from the EV charging station, and adjusting the charge time for the EV, adjusting a charging rate for the EV, or adjusting a grace period associated with the charge time for the EV based on the data indicative of the real-world user activity, wherein after expiration of the charge time and the grace period, the user may be billed a fee for occupying the EV occupying the EV charging station, and a charge controller controlling the EV charging station based on the charge time determined for the EV.

### BRIEF DESCRIPTION OF THE DRAWINGS

FIG. 1 is an exemplary component diagram of a system for electric vehicle (EV) charging station management, according to one aspect.

FIG. 2 is an exemplary component diagram of a system for electric vehicle (EV) charging station management, according to one aspect.

FIG. 3 is an exemplary component diagram of a system for electric vehicle (EV) charging station management, according to one aspect.

FIG. 4 is an exemplary component diagram of a system for electric vehicle (EV) charging station management, according to one aspect.

FIG. 5 is an exemplary flow diagram of a method for electric vehicle (EV) charging station management, according to one aspect.

FIG. 6 is an illustration of an example computer-readable medium or computer-readable device including processor-executable instructions configured to embody one or more of the provisions set forth herein, according to one aspect.

FIG. 7 is an illustration of an example computing environment where one or more of the provisions set forth herein are implemented, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device. The disk may store a database.

A “database”, as used herein, may refer to a table, a set of tables, and a set of data stores (e.g., disks) and/or methods for accessing and/or manipulating those data stores.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle, driving, and/or safety. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

The aspects discussed herein may be described and implemented in the context of non-transitory computer-readable storage medium storing computer-executable instructions. Non-transitory computer-readable storage media include computer storage media and communication media. For example, flash memory drives, digital versatile discs (DVDs), compact discs (CDs), floppy disks, and tape cassettes. Non-transitory computer-readable storage media may include volatile and non-volatile, removable and non-removable media implemented in any method or technology for storage of information such as computer readable instructions, data structures, modules, or other data.

According to one aspect, a system or method for EV charging station management may be initiated via an in-store or other type shopping activity by a user who has an EV charging at an EV charging station the shopping activity by the user may be detected and transmitted to a server, which may effectuate a change in status to the EV charging station which is charging the EV of the user based on tracking of the in-store or other type shopping activity by the user. Additionally, a change in status associated with an account of the user may be effectuated.

Examples of the shopping activity may include a user activity, physically moving an item to a grocery cart of a grocery basket, conducting a monetary transaction above a threshold amount (e.g., checking out using a credit card or smart pay application via a mobile device), dining at a restaurant, adding items to a virtual shopping cart via a shopping application, engaging with products at a store, demoing products at a store, interacting with an employee of a store or retail establishment.

Examples of the change in status to the EV charging station may include adjusting a charge time for the EV at the EV charging station, adjusting a charging rate for the EV at the EV charging station, adjusting a grace period associated with the charge time for the EV at the EV charging station. The charge time for the EV may be an estimated time to full charge of the EV. One or more vehicle systems of the EV may be in computer communication and/or operably connected with the EV charging station and/or the server. After expiration of the charge time and after expiration of the grace period, the user may be billed a fee for occupying the EV occupying the EV charging station space.

An example of the change in status associated with an account of the user being effectuated may include adjusting a status of an order placed by the user via a shopping application based on the indication of the EV initiating charging at the EV charging station. Another example of the change in status associated with an account of the user may include changing a tier associated with the user's account, such as from silver to gold.

According to one aspect, the user may be notified of a potential change in status associated with the account of the user and/or actual changes in status associated with the account of the user. For example, the user may be notified of the adjustment of the charge time for the EV, the adjustment of the charging rate for the EV, the adjustment to the grace period, a potential adjustment to the charge time for the EV, a potential adjustment to the charging rate for the EV, a potential adjustment to the grace period, etc. A potential adjustment may be notified by alerting the user of a threshold prior to the adjustment of aforementioned status changes. These notifications may be implemented to enable the user or customer to be notified to ease the user's mind regarding idle time fees or their grace period expiration. Other incentives may be provided in the form of coupons, loyalty reward points, energy credits, charging credits, free desserts or food or drinks, etc.

In this way, the charging service provider of the EV charging station and the retailers, the stores, the restaurants or dining establishments, or other third parties may be more tightly integrated. In this way, the systems, methods, and/or techniques for electric vehicle (EV) charging station management described herein may trigger charging discounts, incentives, or idle time extensions to be provided for owners of EVs either prior to or after an EV is done charging.

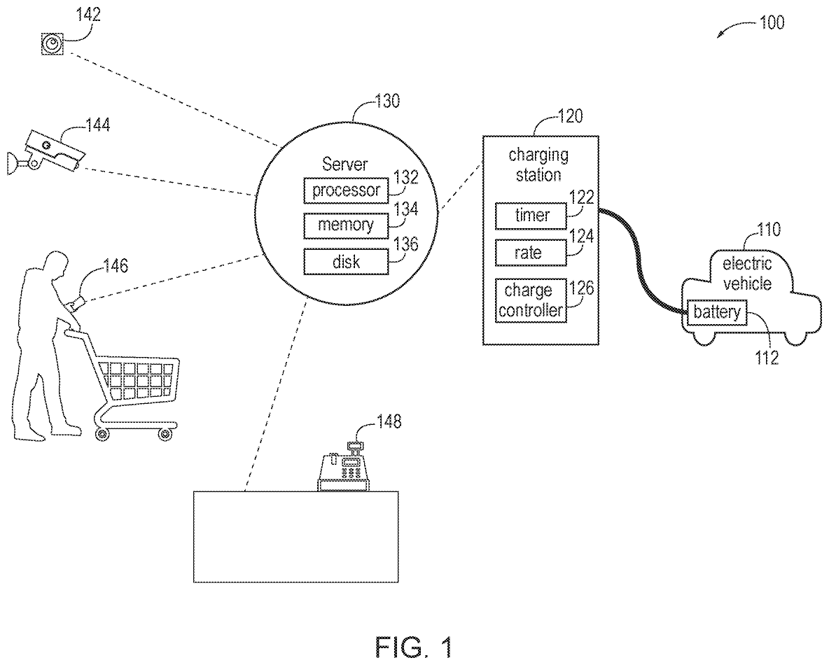

FIG. 1 is an exemplary component diagram of a system 100 for electric vehicle (EV) charging station management, according to one aspect. An electric vehicle (EV) 110 may include an EV battery 112. The EV battery 112 may run low and the EV 110 may be driven to an EV charging station 120 which may be used to charge the EV 110 by connecting the EV charging station 120 to the EV battery 112. The EV charging station 120 may include a timer 122 which determines a time until the EV charge will complete. The EV charging station 120 may include a rate determiner 124 implemented by a processor to determine a billing rate for the user or driver of the EV 110. The charge controller 126 may control charging of the EV 110 and cease charging once the EV charge is complete.

Further, the EV charging station 120 may provide a notification to the user when the EV charge is complete. For example, the EV charging station 120 may be in computer communication or operably connected with a server. The server 130 may include a processor 132, a memory 134, and a disk drive 136. The server 130 may communicate the notification from the EV charging station 120 to a mobile device of the user. The server 130 may be in computer communication or operably connected the mobile device and/or one or more of the third party devices. Although it may be efficient from the EV charging station 120 perspective for the user to immediately move his or her EV 110 from the EV charging station 120 location, this may not necessarily be practical for the user (who may be shopping at a retailer or a store as a customer, for example). In this regard, the system 100 for EV charging station 120 management may receive an indication of user activity from a third party device, communicate this indication to the EV charging station 120, and/or generate an extension of time for the grace period associated with the charge time for the EV 110. The third party device may be a sensor 142, an image capture device 144, a mobile device 146, a payment device 148, etc.

According to one aspect, memory 134 of the server 130 may store instructions that are operable, when executed by the processor 132, to cause the processor 132 to perform one or more acts. For example, the processor 132 may be configured to receive an indication that the EV 110 of the user is initiating charging at the EV charging station 120. In other words, the charge controller 126 of the EV charging station 120 may transmit this indication to the processor 132 of the server 130. The charge controller 126 of the EV charging station 120 may determine the charge time for the EV 110 which may be indicative of an amount of time the EV charging station 120 may supply the charge to the EV 110. The charge time for the EV 110 may be an estimated time to full charge of the EV 110. Thus, after the charge time is complete, the EV 110 may be fully charged and the EV charging station 120 may cease supplying the charge to the EV 110.

The processor 132 may receive, from the third party device, data indicative of a real-world user activity at a location within a threshold distance from the EV charging station 120. As previously discussed, the third party device may come in a variety of different forms, such as, but not limited to a sensor 142, an image capture device 144, an RFID scanner, a mobile device 146, a payment device 148, etc. In response to the receiving of the data indicative of the real-world user activity, the processor 132 may generate and transmit a signal to the charge controller 126 or the timer 122 of the charging station which may adjust the charge time for the EV 110, adjust the charging rate for the EV 110, or adjust a grace period associated with the charge time for the EV 110. According to one aspect, the grace period may be adjusted differently based on the type of user activity detected. Typically, after expiration of the charge time and after the grace period, the user is billed a fee for occupying the EV 110 occupying the EV charging station 120, such as an inactivity or idle fee.

According to one aspect, data received which is indicative of the real-world user activity may be data indicated that the user is physically moving an item to a grocery cart or shopping basket. For example, an image capture device 144 located at a third party retailer may capture this data. In response, the processor 132 may generate the signal to adjust the grace period to extend an additional amount of time beyond a current grace period time frame. Further, the processor 132 may receive data related to the checkout wait time and a distance from the retailer to the EV 110 and factor this time amount into the adjusted grace period. In other words, and for example, if a user (e.g., EV driver who is also a customer at a retailer and/or a user of a mobile device 146) picks up an item at a retail store and places the item in his or her shopping cart, the processor 132 of the server 130 may immediately extend the grace period at the EV charging station 120 for the vehicle by an amount of time at least equal to or greater than a sum of an estimated checkout time, a travel time from the retailer to the EV 110, and a predetermined buffer time. In this way, additional retail activity may be promoted and the relationship between the operator of the EV charging station 120 and the retailer may be enforced.

According to another aspect, the sensor may be an RFID sensor which may be utilized to detect data indicating that the user is physically moving the item to the grocery cart or the shopping basket.

According to yet another aspect, the payment device 148 may be the third party device and may transmit the data indicative of the real-world user activity to the processor 132 of the server 130 when a purchase is made by the user. As used herein the user may be the driver of the EV 110, the customer of the store or retailer, and the user of the mobile device 146 and/or a party in privity with the driver of the EV 110. In this scenario, the processor 132 of the server 130 may extend the grace period at the EV charging station 120 for the vehicle by an amount of time at least equal to or greater than the travel time from the retailer to the EV 110 and the predetermined buffer time.

The processor 132 may additional extend the grace period at the EV charging station 120 for the vehicle based on a global positioning system (GPS) position of the mobile device 146 of the user and a to-do list or shopping list on the mobile device 146. For example, if the to-do list of the user includes a first retailer and a second retailer, the processor 132 may extend the grace period an amount of time based on a buffer time or estimated shopping time at the first retailer, a travel time from the first retailer to the second retailer, an estimated shopping time at the second retailer, and an estimated travel time from the second retailer to the EV 110. As another example, if the to-do list includes a return at the first retailer, the processor 132 may extend the grace period an amount of time based on an estimated return time associated with standing in line at customer service at the first retailer, etc.

According to another aspect, the payment device 148 may be the third party device and may transmit the data indicative of the real-world user activity to the processor 132 of the server 130 when the purchase is made by the user is greater than a threshold amount. In other words, the real-world user activity may include a monetary transaction above the threshold amount.

The processor 132 of the server 130 may generate a notification for the user of the adjustment of the charge time for the EV 110, the adjustment of the charging rate for the EV 110, or the adjustment to the grace period, thereby enabling the user to enjoy his or her retail shopping experience without worrying about idle fees or penalties associated with parking the EV 110 at the EV charging station 120. Further, according to another aspect, the processor 132 may notify the user of a threshold prior to the adjustment of the charge time for the EV 110, the adjustment of the charging rate for the EV 110, or the adjustment to the grace period. Stated another way, the processor 132 may notify the user of a potential for an incentive or extension for the grace period. For example, the processor 132 of the server 130 may indicate to the user, via the mobile device 146, that an extension of time may be available for the grace period if another twenty dollars is spent. Other conditions to providing the extension of time to the grace period may be contemplated as well, such as physically moving an item to a grocery cart or a basket, a monetary transaction above a threshold amount, dining at a restaurant, adding items to a virtual shopping cart via a shopping application, interacting with an employee of a retail establishment, demoing a product, etc.

According to another aspect, the user or EV driver may park his or her vehicle at the EV charging station 120 and begin to add items to a virtual shopping cart via a shopping application. Based on the addition of these items to the virtual shopping cart via the shopping application, the processor 132 may determine that the grace period is to be extended. Further, the processor 132 may adjust a status of an order placed by the user via the shopping application based on the indication of the EV 110 initiating charging at the EV charging station 120. In other words, the processor 132 may expedite the order for the user parked at the EV charging station 120 over other orders of shoppers who are not currently near the retailer.

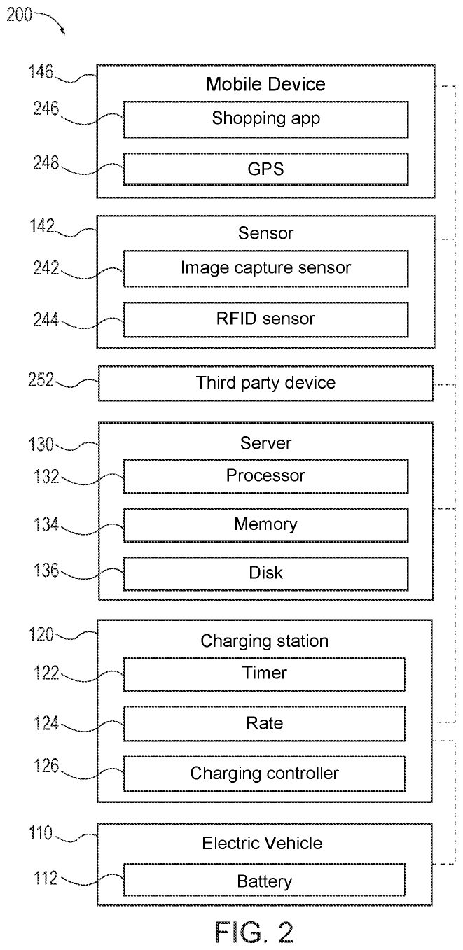

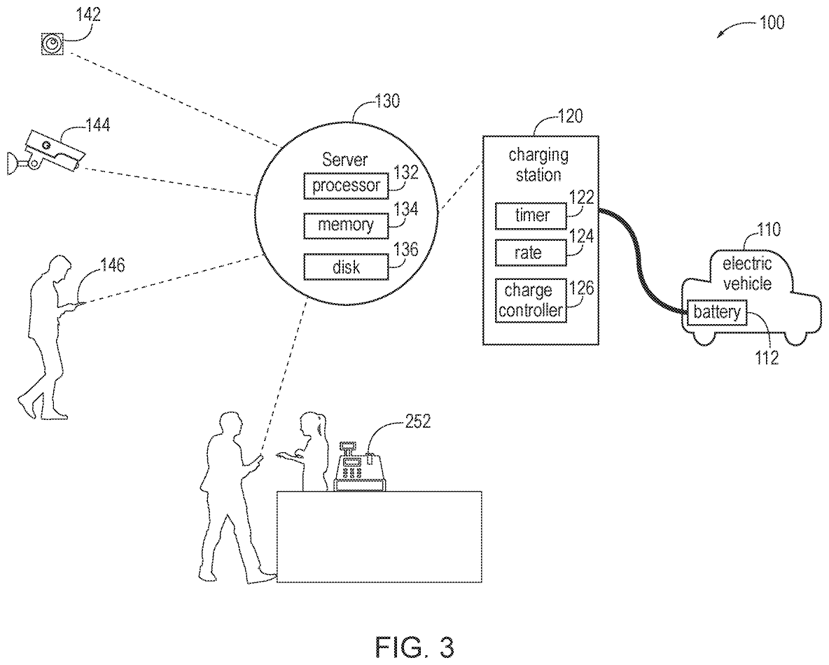

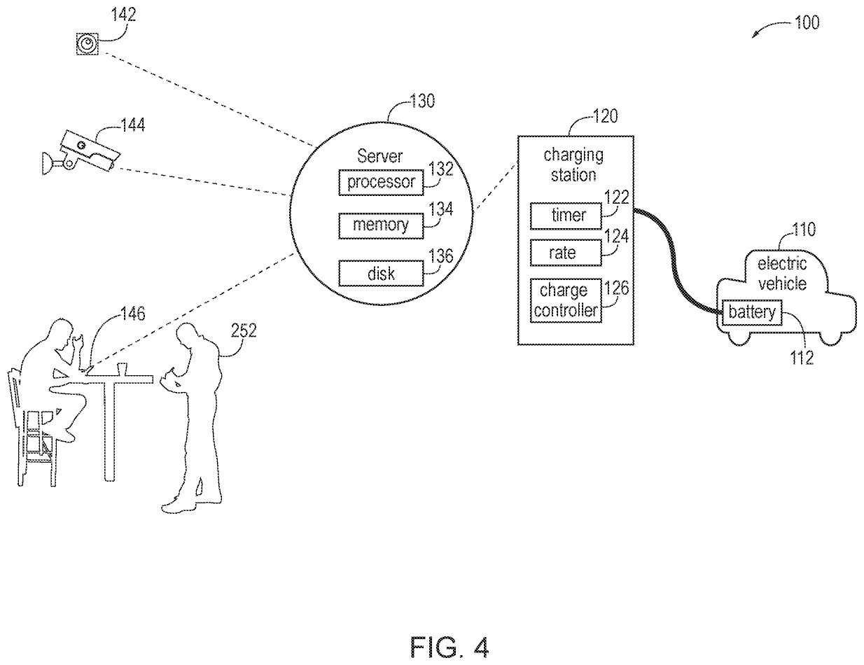

FIG. 2 is an exemplary component diagram of a system 200 for electric vehicle (EV) charging station management illustrated in block diagram format, according to one aspect. As seen in FIG. 2, the mobile device 146 may run or execute a shopping application 246 and/or provide the server 130 with a GPS location of the user or driver of the EV for the mobile device 146 using a GPS antenna 248. The sensor 142 may be an image capture sensor 242 or an RFID 244 or other near field type sensor for detecting items being placed in a grocery or shopping basket or cart of the user. Additionally, a third party device 252 may be utilized to communicate with the server 130, as will be discussed in FIGS. 3-4.

FIG. 3 is an exemplary component diagram of a system for electric vehicle (EV) charging station management, according to one aspect. According to this aspect, the third party device may be an image capture device 144 or a third party device 252 which may track the user activity. In this example, the user or EV driver may request help from a store or retailer employee. Although a purchase is not necessarily being made (e.g., a warranty repair may occur, or home repair advice may be provided, etc.), the processor 132 of the server 130 may receive this information indicative of the real-world user activity of the interaction with the retailer employee and credit or extend the grace period of the EV at the EV charging station 120 in this regard and/or based thereon. According to one aspect, the image capture device 144 may determine, record or track this user activity. According to another aspect, the store employee may provide an input to the third party device 252 (which may be a third party mobile device), which may be transmitted to the server 130, thereby resulting in the extension of time for the grace period.

FIG. 4 is an exemplary component diagram of a system for electric vehicle (EV) charging station management, according to one aspect. According to another aspect, the extension of time to the grace period may be provided based on a dining experience at a restaurant. The extension of time for the grace period may be calculated based on a variety of ways, such as based on a monetary transaction above a threshold amount at the restaurant tracked by the third party device 252, an estimated dining time based on the food ordered, whether the transaction is a dine-in or take-out transaction, an estimated food preparation time, the GPS location of the user (e.g., if the user is located at the restaurant for an extended period of time, the dine-in status may be inferred), an input to the third party device 252, which may be a beeper tracking a reservation status of the user, etc.

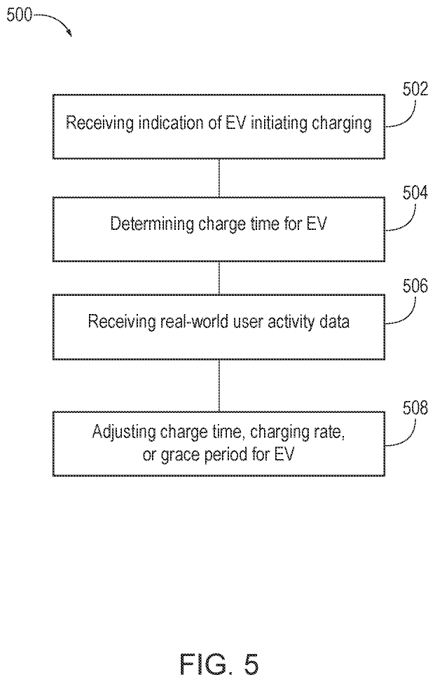

FIG. 5 is an exemplary flow diagram of a computer implemented method 500 for electric vehicle (EV) charging station management, according to one aspect. The computer implemented method 500 for EV charging station management may include receiving 502 an indication of an EV of a user initiating charging at an EV charging station 120, determining 504 a charge time for the EV, the charge time indicative of an amount of time the EV charging station 120 supplies a charge to the EV, receiving 506 data indicative of a real-world user activity at a location within a threshold distance from the EV charging station 120, and adjusting 508 the charge time for the EV, adjusting a charging rate for the EV, or adjusting a grace period associated with the charge time for the EV based on the data indicative of the real-world user activity, wherein after expiration of the charge time and the grace period. The user may be billed a fee for occupying the EV occupying the EV charging station 120.

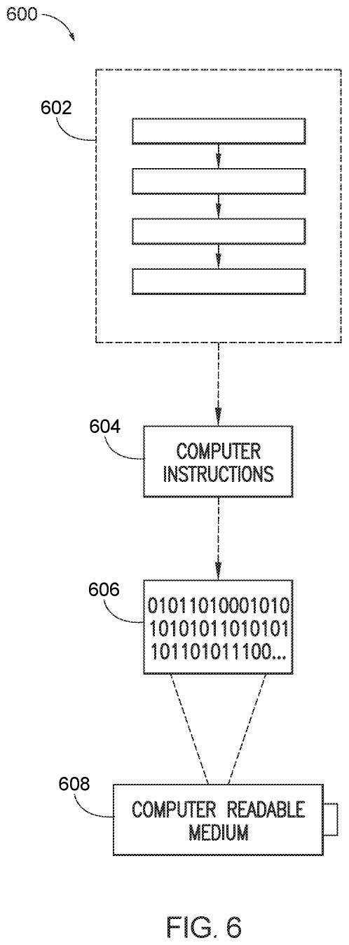

Still another aspect involves a computer-readable medium including processor-executable instructions configured to implement one aspect of the techniques presented herein. An aspect of a computer-readable medium or a computer-readable device devised in these ways is illustrated in FIG. 6, wherein an implementation 600 includes a computer-readable medium 608, such as a CD-R, DVD-R, flash drive, a platter of a hard disk drive, etc., on which is encoded computer-readable data 606. This encoded computer-readable data 606, such as binary data including a plurality of zero's and one's as shown in 606, in turn includes a set of processor-executable computer instructions 604 configured to operate according to one or more of the principles set forth herein. In this implementation 600, the processor-executable computer instructions 604 may be configured to perform a method 602, such as the method or computer implemented method 500 of FIG. 5. In another aspect, the processor-executable computer instructions 604 may be configured to implement a system, such as the system 100 of FIG. 1, the system 200 of FIG. 2, the system 300 of FIG. 3, and/or the system 400 of FIG. 4. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

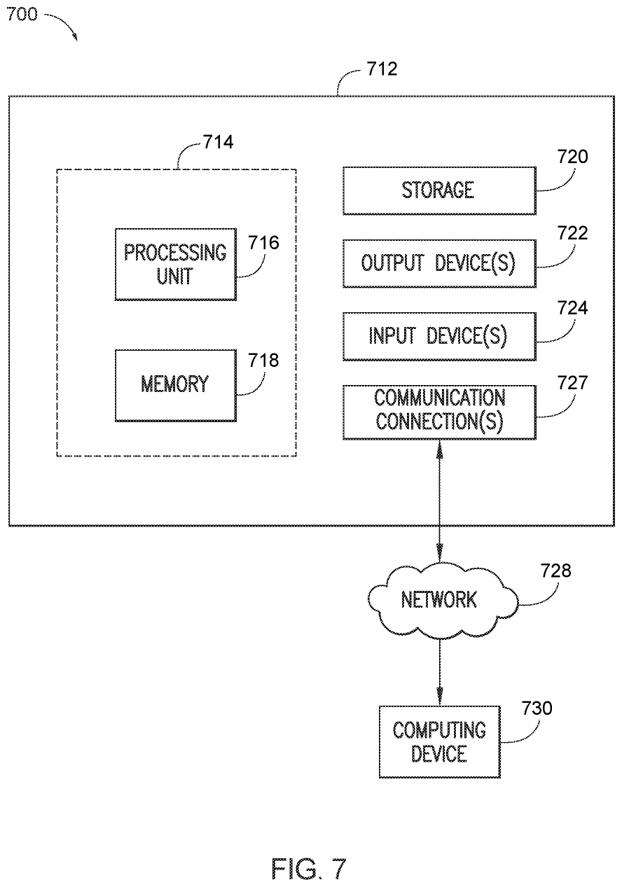

FIG. 7 and the following discussion provide a description of a suitable computing environment to implement aspects of one or more of the provisions set forth herein. The operating environment of FIG. 7 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 7 illustrates a system 700 including a computing device 712 configured to implement one aspect provided herein. In one configuration, the computing device 712 includes at least one processing unit 716 and memory 718. Depending on the exact configuration and type of computing device, memory 718 may be volatile, such as RAM, non-volatile, such as ROM, flash memory, etc., or a combination of the two. This configuration is illustrated in FIG. 7 by dashed line 714.

In other aspects, the computing device 712 includes additional features or functionality. For example, the computing device 712 may include additional storage such as removable storage or non-removable storage, including, but not limited to, magnetic storage, optical storage, etc. Such additional storage is illustrated in FIG. 7 by storage 720. In one aspect, computer readable instructions to implement one aspect provided herein are in storage 720. Storage 720 may store other computer readable instructions to implement an operating system, an application program, etc. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 712. Any such computer storage media is part of the computing device 712.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 712 includes input device(s) 724 such as keyboard, mouse, pen, voice input device, touch input device, infrared cameras, video input devices, or any other input device. Output device(s) 722 such as one or more displays, speakers, printers, or any other output device may be included with the computing device 712. Input device(s) 724 and output device(s) 722 may be connected to the computing device 712 via a wired connection, wireless connection, or any combination thereof. In one aspect, an input device or an output device from another computing device may be used as input device(s) 724 or output device(s) 722 for the computing device 712. The computing device 712 may include communication connection(s) 726 to facilitate communications with one or more other devices 730, such as through network 728, for example.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for electric vehicle (EV) charging station management, comprising:
a processor and a memory storing instructions that are operable, when executed by the processor, to cause the processor to perform:
receiving an indication of an EV of a user initiating charging at an EV charging station;
determining a charge time for the EV, the charge time indicative of an amount of time the EV charging station supplies a charge to the EV;
receiving data indicative of a real-world user activity at a location within a threshold distance from the EV charging station; and
adjusting a grace period associated with the charge time for the EV based on the data indicative of the real-world user activity, wherein after expiration of the charge time and the grace period, the user is billed a fee for occupying the EV occupying the EV charging station.

2. The system for electric vehicle (EV) charging station management of claim 1, wherein the charge time for the EV is an estimated time to full charge of the EV.

3. The system for electric vehicle (EV) charging station management of claim 1, wherein the real-world user activity includes physically moving an item to a grocery cart or a basket.

4. The system for electric vehicle (EV) charging station management of claim 1, wherein the real-world user activity includes a monetary transaction above a threshold amount.

5. The system for electric vehicle (EV) charging station management of claim 1, wherein the real-world user activity includes a dining experience at a restaurant.

6. The system for electric vehicle (EV) charging station management of claim 1, wherein the real-world user activity includes adding items to a virtual shopping cart via a shopping application.

7. The system for electric vehicle (EV) charging station management of claim 1, wherein the processor notifies the user of the adjustment of the charge time for the EV, the adjustment of the charging rate for the EV, or the adjustment to the grace period.

8. The system for electric vehicle (EV) charging station management of claim 1, wherein the processor notifies the user of a threshold prior to the adjustment of the charge time for the EV, the adjustment of the charging rate for the EV, or the adjustment to the grace period.

9. The system for electric vehicle (EV) charging station management of claim 1, wherein the real-world user activity includes an interaction with an employee of a retail establishment.

10. The system for electric vehicle (EV) charging station management of claim 1, wherein the processor adjusts a status of an order placed by the user via a shopping application based on the indication of the EV initiating charging at the EV charging station.

11. A computer implemented method for electric vehicle (EV) charging station management, comprising:
receiving an indication of an EV of a user initiating charging at an EV charging station;
determining a charge time for the EV, the charge time indicative of an amount of time the EV charging station supplies a charge to the EV;
receiving data indicative of a real-world user activity at a location within a threshold distance from the EV charging station; and
adjusting a grace period associated with the charge time for the EV based on the data indicative of the real-world user activity, wherein after expiration of the charge time and the grace period, the user is billed a fee for occupying the EV occupying the EV charging station.

12. The method for electric vehicle (EV) charging station management of claim 11, wherein the charge time for the EV is an estimated time to full charge of the EV.

13. The method for electric vehicle (EV) charging station management of claim 11, wherein the real-world user activity includes physically moving an item to a grocery cart or a basket.

14. The method for electric vehicle (EV) charging station management of claim 11, wherein the real-world user activity includes a monetary transaction above a threshold amount.

15. The method for electric vehicle (EV) charging station management of claim 11, wherein the real-world user activity includes a dining experience at a restaurant.

16. The method for electric vehicle (EV) charging station management of claim 11, wherein the real-world user activity includes adding items to a virtual shopping cart via a shopping application.

17. The method for electric vehicle (EV) charging station management of claim 11, comprising notifying the user of the adjustment of the charge time for the EV, the adjustment of the charging rate for the EV, or the adjustment to the grace period.

18. The method for electric vehicle (EV) charging station management of claim 11, comprising notifying the user of a threshold prior to the adjustment of the charge time for the EV, the adjustment of the charging rate for the EV, or the adjustment to the grace period.

19. The method for electric vehicle (EV) charging station management of claim 11, wherein the real-world user activity includes an interaction with an employee of a retail establishment.

20. A system for electric vehicle (EV) charging station management, comprising:
a processor and a memory storing instructions that are operable, when executed by the processor, to cause the processor to perform:
receiving an indication of an EV of a user initiating charging at an EV charging station;
determining a charge time for the EV, the charge time indicative of an amount of time the EV charging station supplies a charge to the EV;
receiving data indicative of a real-world user activity at a location within a threshold distance from the EV charging station; and
adjusting a grace period associated with the charge time for the EV based on the data indicative of the real-world user activity, wherein after expiration of the charge time and the grace period, the user is billed a fee for occupying the EV occupying the EV charging station; and
a charge controller controlling the EV charging station based on the charge time determined for the EV.
